(19) United States
(12) Patent Application Publication
(10) Pub. No.: US 2022/0400040 A1
(43) Pub. Date: Dec. 15, 2022

(54) METHOD AND APPARATUS FOR DETERMINING REFERENCE SIGNAL INFORMATION, STORAGE MEDIUM AND TERMINAL

(71) Applicant: BEIJING UNISOC COMMUNICATIONS TECHNOLOGY CO., LTD., Beijing (CN)

(72) Inventor: Hualei WANG, Shanghai (CN)

(73) Assignee: BEIJING UNISOC COMMUNICATIONS TECHNOLOGY CO., LTD., Beijing (CN)

(21) Appl. No.: 17/627,467

(22) PCT Filed: Apr. 27, 2020
(86) PCT No.: PCT/CN2020/087195

§ 371 Date: Jan. 14, 2022

(30) Foreign Application Priority Data
Jul. 16, 2019 (CN) 201910640762.0

(51) Int. Cl. H04L 27/26; H04L 5/00

(52) U.S. Cl. CPC H04L 27/261; H04L 5/0048; H04L 5/0007

(57) ABSTRACT

A signal transmitting method and apparatus, a storage medium, and a user terminal are provided. The method includes: receiving a network configuration information, wherein the network configuration information at least comprises a position of an Orthogonal Frequency Division Multiplexing (OFDM) symbol occupied by the RS information; and determining the RS information based on the position of the OFDM symbol occupied by the RS information.

### CROSS-REFERENCE TO RELATED APPLICATIONS

This application is the national phase of International Application No. PCT/CN2020/087195, filed on Apr. 27, 2020, which claims priority to Chinese Patent Application No. 201910640762.0, filed on Jul. 16, 2019, and entitled “METHOD AND APPARATUS FOR DETERMINING REFERENCE SIGNAL INFORMATION, STORAGE MEDIUM AND TERMINAL”, the entire disclosure of which is incorporated herein by reference.

### TECHNICAL FIELD

The present disclosure generally relates to communication technology field, and more particularly, to a method and apparatus for determining reference signal information, storage medium and terminal.

### BACKGROUND

Currently, a downlink system of the Third Generation Partnership Project (3GPP) uses a Cyclic Prefix-Orthogonal Frequency Division Multiplexing (CP-OFDM) waveform. That is, a downlink data and a Reference Signal (RS) are frequency domain signals, wherein the RS information used for a Channel State Information (CSI) interference measurement is a frequency domain reference signal, and the data needs to perform a rate matching on the RS information.

However, in an existing technology, for a Downlink (DL) system with a single-carrier waveform, a method for determining the RS information is needed.

### SUMMARY

Embodiments of the present disclosure provide a method for determining an RS information.

In an embodiment of the present disclosure, a method for transmitting signal is provided, the method includes: receiving a network configuration information, wherein the network configuration information at least includes a position of an Orthogonal Frequency Division Multiplexing (OFDM) symbol occupied by the RS information; and determining the RS information based on the position of the OFDM symbol occupied by the RS information.

In an embodiment of the present disclosure, a non-transitory storage medium is provided, the storage medium storing one or more programs, the one or more programs comprising computer instructions, which, when executed by a processor, cause the processor to: receive a network configuration information, wherein the network configuration information at least comprises a position of an Orthogonal Frequency Division Multiplexing (OFDM) symbol occupied by the RS information; and determine the RS information based on the position of the OFDM symbol occupied by the RS information.

In an embodiment of the present disclosure, a terminal is provided, the terminal includes a memory and a processor, wherein the memory has computer instructions stored therein, which, when executed by a processor, cause the processor to: receive a network configuration information, wherein the network configuration information at least comprises a position of an Orthogonal Frequency Division Multiplexing (OFDM) symbol occupied by the RS information; and determine the RS information based on the position of the OFDM symbol occupied by the RS information.

### BRIEF DESCRIPTION OF THE DRAWINGS

FIG. 1 schematically illustrates a schematic diagram of a position of an RE occupied by an RS information according to an existing technology;

FIG. 2 schematically illustrates a flowchart of a method for determining an RS information according to an embodiment of the present disclosure;

FIG. 3 schematically illustrates a schematic diagram of a position of an RE occupied by an RS information according to an embodiment of the present disclosure;

FIG. 4 schematically illustrates a schematic diagram of a position of an RE occupied by an RS information according to another embodiment of the present disclosure;

FIG. 5 schematically illustrates a schematic diagram of a position of a Sample occupied by an RS information according to an embodiment of the present disclosure;

FIG. 6 schematically illustrates a part of a flowchart of a method for determining an RS information according to another embodiment of the present disclosure;

FIG. 7 schematically illustrates a structural diagram of an apparatus for determining an RS information according to an embodiment of the present disclosure.

### DETAILED DESCRIPTION

As mentioned before, currently, a downlink system of the 3GPP uses a CP-OFDM waveform, that is, a downlink data and an RS are frequency domain signals, wherein the RS information used for a CSI interference measurement is a frequency domain RS, and the data needs to perform a rate matching on the RS information. Specifically, the 3GPP can support two patterns.

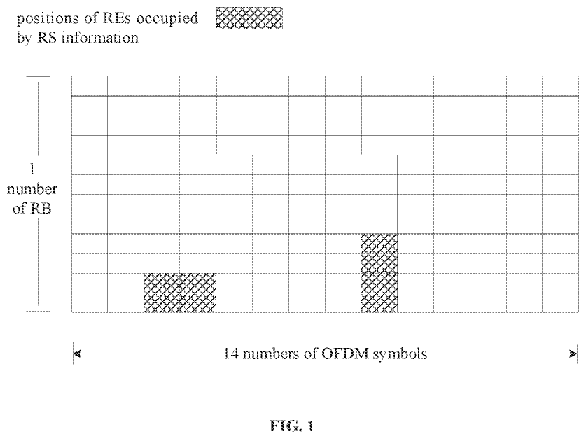

Referring to FIG. 1, FIG. 1 schematically illustrates a schematic diagram of a position of an RE occupied by an RS information according to an existing technology;

Specifically, pattern 1 may occupy 2 numbers of continuous OFDM symbols, occupied REs on each OFDM symbol are correspondent, and the pattern 1 occupies two continuous REs in a single RB on each OFDM symbol. Pattern 2 occupies 1 number of OFDM symbol, and occupies four continuous REs in a single RB. And for the two patterns, it can occupy any one of 14 numbers of OFDM symbols in one slot.

As shown in FIG. 1, pattern 1 occupies the third and the fourth OFDM symbols and occupies the first and the second REs in a single RB on each OFDM symbol. Pattern 2 occupies the ninth OFDM symbol and occupies the first to the fourth REs in a single RB on the ninth OFDM symbol. And the two patterns are at the corresponding positions of the REs in each RB.

Inventors found that in the existing technology, for a DL system with a single carrier waveform, such as a satellite system and a high-frequency system, a method for determining an RS information is needed.

In embodiments of the present disclosure, a terminal may receive a network configuration information, wherein the network configuration information includes a position of an OFDM symbol occupied by the RS information and the terminal may determine the RS information based on the position of the OFDM symbol occupied by the RS information. According to embodiments of the present disclosure, the RS information may be determined based on the position of the OFDM symbol occupied by the RS information, which can realize to determine the RS information in the system with a single carrier waveform.

In order to clarify the object, characteristic and advantages of embodiments of the present disclosure, the embodiments of present disclosure will be described clearly in detail in conjunction with accompanying drawings.

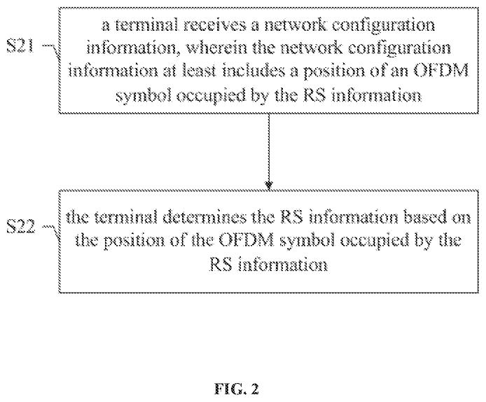

Referring to FIG. 2, FIG. 2 schematically illustrates a flowchart of a method for determining an RS information according to an embodiment of the present disclosure; the method may include the following S21, and S22.

In S21, a terminal receives a network configuration information, wherein the network configuration information at least includes a position of an OFDM symbol occupied by the RS information.

In S22, the terminal determines the RS information based on the position of the OFDM symbol occupied by the RS information.

In a specific embodiment of S21, the RS information may be mainly used for a CSI interference measurement.

The network configuration information may be used for indicating the RS information, so that a receiving end (such as a terminal) can determine the RS information.

In a specific embodiment of S22, the terminal may determine the RS information based on the position of the OFDM symbol occupied by the RS information.

Specifically, the terminal may determine the pattern as a pattern in different resource cells based on whether the RS information occupies REs or Samples on the OFDM symbol. Specifically, if the RS information occupies the REs on the OFDM symbol, the terminal may determine the pattern as a time-frequency domain resource cell; if the RS information occupies the Sample on the OFDM symbol or on an OFDM symbol before transform pre-coding, the terminal may determine the pattern as a time domain resource cell of a Sample level.

Wherein, the terminal may determine patterns in different resource cells based on whether the RS information occupies RBs or Sample RBs on the OFDM symbol. Specifically, if the RS information occupies the RBs on the OFDM symbol, the terminal may determine the pattern as a time-frequency domain resource cell; if the RS information occupies the Sample RBs on the OFDM symbol or on an OFDM symbol before transform pre-coding, the terminal may determine the pattern as a time domain resource cell of a Sample level. Wherein, an RB includes a plurality of continuous subcarriers, and a Sample RB includes a plurality of continuous Samples. It should be pointed out that, if the RS information occupies the REs on the OFDM symbol, positions of the subcarriers need to be configured in the network configuration information; if the RS information occupies the Samples on the OFDM symbol, relevant information of the Samples need to be configured in the network configuration information. In some embodiment, the Index number of the Samples may be configured in the network configuration information.

It should be understood that, in some embodiment, the terminal may also configure information which is used to identify positions of the subcarriers, that is, the terminal may also configure upstream information of the positions of the subcarriers. This solution is also applicable to LTE/NR system, which should be regarded as a change and modification without departing from the spirit and scope of the present disclosure.

It should be understood that, in some embodiment, the terminal may also configure information which is used to identify positions of the Samples, that is, the terminal may also configure upstream information of the positions of the Samples. This solution is also applicable to LTE/NR system, which should be regarded as a change and modification without departing from the spirit and scope of the present disclosure.

According to embodiments of the present disclosure, the RS information may be determined based on the OFDM symbol occupied by the RS information, which can realize to determine the RS information in the system with a single carrier waveform.

For the case that the RS information occupies REs on the OFDM symbol, in an embodiment of the present disclosure, the network configuration information also includes positions of subcarriers, and the RS information occupies one OFDM symbol and all REs on the one OFDM symbol.

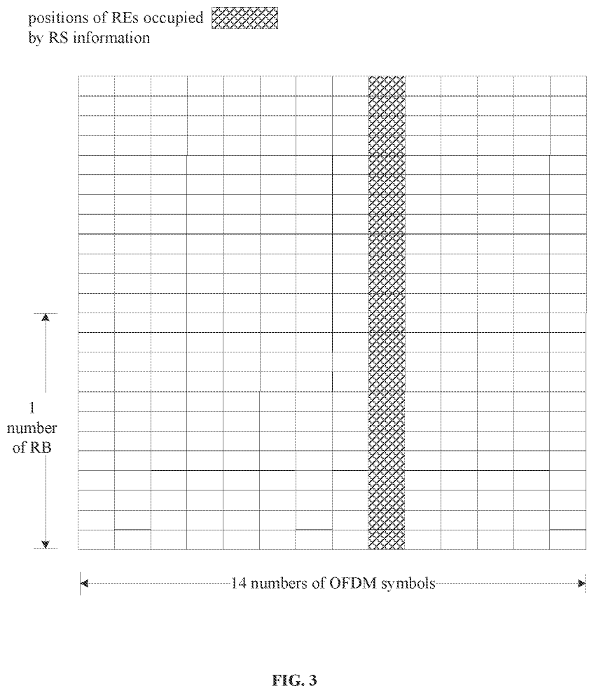

Referring to FIG. 3, FIG. 3 schematically illustrates a schematic diagram of a position of an RE occupied by an RS information according to an embodiment of the present disclosure.

Specifically, the RS information may occupy one of the OFDM symbols, and occupy all REs on the occupied OFDM symbol. For example, the RS information occupies the ninth OFDM symbol.

It should be pointed out that the RS information may also occupy a plurality of OFDM symbols.

In another embodiment of the present disclosure, the network configuration information also includes positions of subcarriers, and the RS information occupies 1 number of OFDM symbol and a part of REs on the occupied OFDM symbol.

Furthermore, on each OFDM symbol, a number of the REs in each RB occupied by the RS information may be (4x, 4x+1, 4x+2, 4x+3); or, on each OFDM symbol, the number of the REs in each RB occupied by the RS information may be (2x, 2x+1); wherein, x is a integer and x≥0.

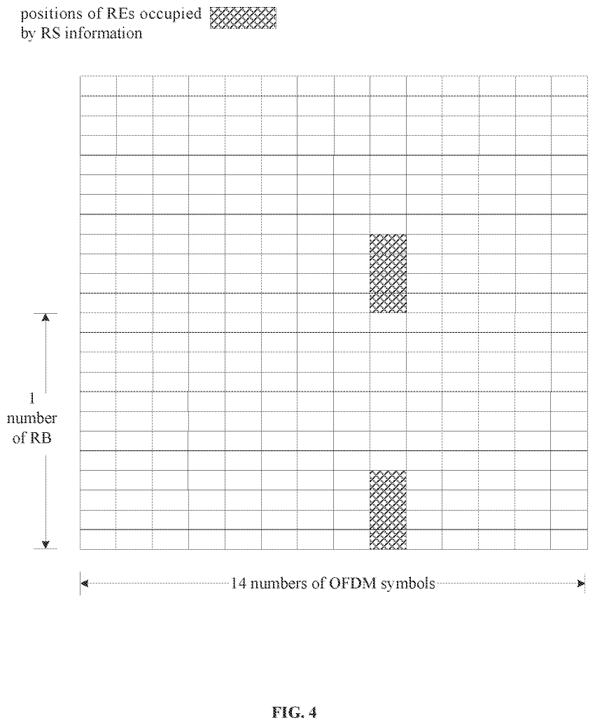

Referring to FIG. 4, FIG. 4 schematically illustrates a schematic diagram of a position of an RE occupied by RS information according to another embodiment of the present disclosure.

Specifically, the RS information may occupy one of the OFDM symbols, for example, the ninth OFDM symbol, and the RS information may occupy a part of REs in a single RB on the occupied OFDM symbol, for example, the first to the fourth REs, that is, the number of the REs is (0, 1, 2, 3).

It should be pointed out that the RS information may also occupy a plurality of OFDM symbols, and positions of REs in a single RB on each OFDM symbol occupied by the RS information are correspondent.

It should be pointed out that the number of the REs in each RB occupied by the RS information may also be other appropriate numbers, such as (4,5,6,7), (8,9,10,11), (0,1), (2,3), (4,5), (6,7), (8,9), (10,11) or (4,7).

In embodiments of the present disclosure, by configuring the RS information to occupy a single or a plurality of OFDM symbols, the occupancy of the positions of the RE is helpful to further determine the RS information.

For the case that the RS information occupies Samples on the OFDM symbol, in an embodiment of the present disclosure, the network configuration information may include information of positions of Samples, and the RS information occupies one OFDM symbol and all Samples in a single Sample RB on the OFDM symbol.

In another embodiment of the present disclosure, the network configuration information may include information of positions of Samples; the RS information may occupy a plurality of OFDM symbols and occupies a part of the Samples on each of the plurality of OFDM symbols, wherein positions of the Samples occupied in each Sample RB on each of the plurality of OFDM symbols are correspondent.

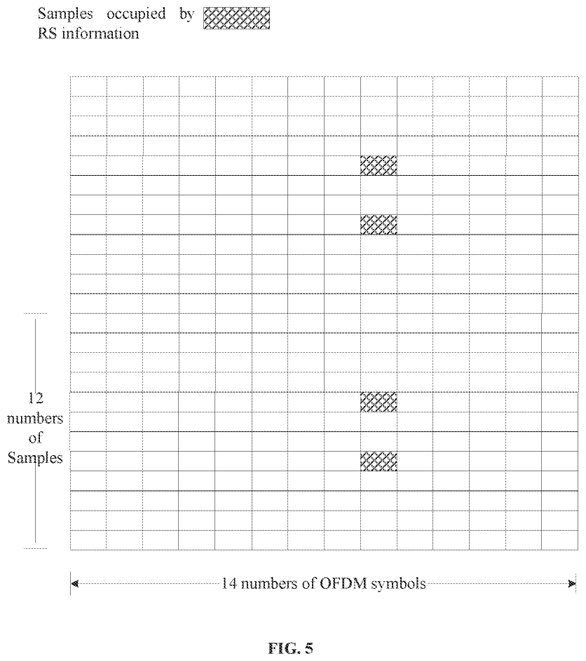

Referring to FIG. 5, FIG. 5 schematically illustrates a schematic diagram of a position of a Sample occupied by an RS information according to an embodiment of the present disclosure.

Specifically, the RS information may occupy one of the OFDM symbols, for example, the ninth OFDM symbol, and the RS information may occupy a part of Samples in a single Sample RB on the occupied OFDM symbol, for example, the first to the fourth Samples, that is, position information of the Samples is (0, 1, 2, 3).

It should be pointed out that the RS information may also occupy a plurality of OFDM symbols, and positions of Samples in a single Sample RB on each of the plurality of OFDM symbol occupied by the RS information are correspondent.

Furthermore, on each OFDM symbol, a position information of the Sample in each Sample RB occupied by the RS information may be (4y, 4y+1, 4y+2, 4y+3); or, on each OFDM symbol, a position information of the Sample in each Sample RB occupied by the RS information may be (2y, 2y+1); wherein, y is a integer and y≥0.

Specifically, positions information of Samples in each Sample RB occupied by the RS information may also be other appropriate numbers, such as (4, 5, 6, 7), (8, 9, 10, 11), (0, 1), (2, 3), (4, 5), (6, 7), (8, 9), (10, 11) or (4, 7).

In embodiments of the present disclosure, by setting the RS information to occupy a single or a plurality of OFDM symbols, the occupancy of positions information of Samples is helpful to further determine the RS information.

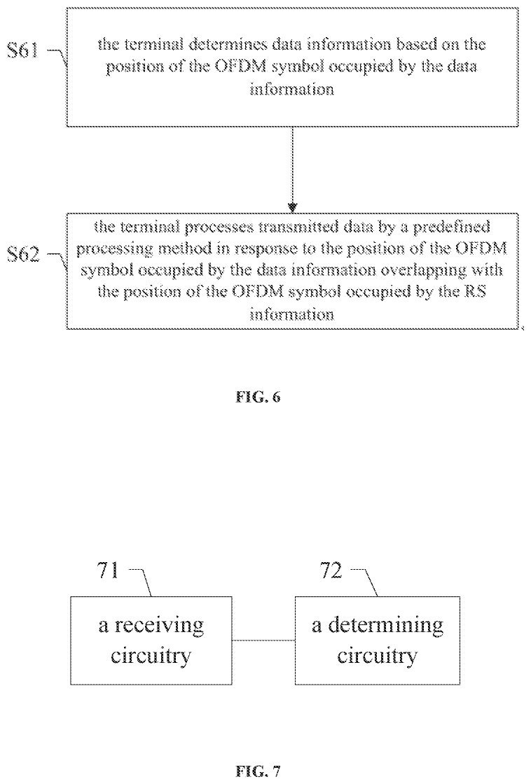

Referring to FIG. 6, FIG. 6 schematically illustrates a part of a flowchart of a method for determining an RS information according to another embodiment of the present disclosure. The method may include S21 and S22 as shown in FIG. 2 and may also include the following S61, and S62.

In S61, the terminal determines data information based on the position of the OFDM symbol occupied by the data information.

In S62, the terminal processes transmitted data by a predefined processing method in response to the position of the OFDM symbol occupied by the data information overlapping with the position of the OFDM symbol occupied by the RS information.

Wherein, the network configuration information may also include a position of an OFDM symbol occupied by the data information which is used for transmitting data.

In a specific embodiment of S61, the network configuration information may be used for indicating the data, so that the receiving end (such as a terminal) can determine the data.

Specifically, the terminal may determine the pattern as a pattern in different resource cells based on whether the RS information occupies REs or Samples on the OFDM symbol. Specifically, if the RS information occupies the REs on the OFDM symbol, the terminal may determine the pattern as a time-frequency domain resource cell; if the RS information occupies the Sample on the OFDM symbol, the terminal may determine the pattern as a time domain resource cell of a Sample level.

It can be understood that, currently, an RE time-frequency domain resource cell may be used to characterize a resource naming and division of a multi-carrier system, and a time domain resource cell of a Sample level may be used to characterize a resource naming and division of a single-carrier system. However, the specific application scope of the embodiments of the present disclosure is not limited to this. If there are other suitable methods for dividing resources, it can also be regarded as changes and modifications without departing from the spirit and scope of the present disclosure.

It should be pointed out that, if the data information occupies the REs on the OFDM symbols, positions of the subcarriers need to be configured in the network configuration information; if the data information occupies the Samples on the OFDM symbol, relevant information of the Samples need to be configured in the network configuration information. In some embodiment, the position information of the Samples may be configured in the network configuration information.

It should be understood that, in some embodiment, the terminal may also configure information which is used to identify positions of the subcarriers, that is, the terminal may also configure upstream information of the positions of the subcarriers. This solution is also applicable to LTE/NR system, which should be regarded as a change and modification without departing from the spirit and scope of the present disclosure.

It should be understood that, in some embodiment, the terminal may also configure information which is used to identify positions of the Samples, that is, the terminal may also configure upstream information of the positions of the Samples. This solution is also applicable to LTE/NR system, which should be regarded as a change and modification without departing from the spirit and scope of the present disclosure.

In a specific embodiment of S62, the terminal may process the transmitted data by a predefined processing method in response to the position of the OFDM symbol occupied by the data information overlapping with the position of the OFDM symbol occupied by the RS information.

In an embodiment of the present disclosure, the network configuration information may also include positions of subcarriers which are used for transmitting data information of a data, wherein the data information includes information after Fourier transform. The terminal processing the transmitted data by a predefined processing method may include: the terminal maps the data to a position of the OFDM symbol occupied by the data information other than an overlapped position; or maps the data to a position of the OFDM symbol occupied by the data information other than the position of the OFDM symbol occupied by the RS information. In the embodiment of the present disclosure, by mapping the data to a position occupied by the data information other than the overlapped position or mapping the data to a position occupied by the data information other than the position of the OFDM symbol occupied by the RS information, it facilitates the transmission of the RS information.

In another embodiment of the present disclosure, the network configuration information also includes positions of subcarriers occupied by the data information which are used for transmitting data, wherein the data information includes information after Fourier transform. The terminal processing the transmitted data by a predefined processing method may include: the terminal maps the data information to positions of the subcarriers, and discarding data mapped to an overlapped position; or the terminal maps the data information to all positions of the OFDM symbols and discarding data of all positions of an OFDM symbol which is mapped to the overlapping position.

In the embodiment of the present disclosure, setting a mapping between the data information and the subcarriers or the mapping between the data information and the symbols helps to transmit the RS information.

Further, the network configuration information also includes positions of Samples which are used for transmitting data, wherein the data information includes information before Fourier transform; the terminal processing the transmitted data by the predefined processing method may include: the terminal may map the data to a position of the OFDM symbol occupied by the data information other than an overlapped position; or the terminal may map the data to a position of the OFDM symbol occupied by the data information other than the position of the OFDM symbol occupied by the RS information.

In the embodiment of the present disclosure, mapping the data to a position of the OFDM symbol occupied by the data information other than the overlapped position or mapping the data to a position of the OFDM symbol occupied by the data information other than the position of the OFDM symbol occupied by the RS information helps the transmission of the RS information.

Further, the network configuration information also includes positions of Samples of the data information which are used for transmitting data, wherein the data information includes information after Fourier transform; the terminal processing the transmitted data by the predefined processing method may include: the terminal may map the data information to the positions of the Samples, and discarding data mapped to an overlapped position; or the terminal may map the data information to positions of all OFDM symbols and discard data of all positions of an OFDM symbol which is mapped to an overlapping positions.

Referring to FIG. 7, FIG. 7 schematically illustrates a structural diagram of an apparatus for determining an RS information according to an embodiment of the present disclosure. The apparatus may include a receiving circuitry 71, and a determining circuitry 72.

The receiving circuitry 71 is adapted to receive a network configuration information, wherein the network configuration information at least includes a position of an Orthogonal Frequency Division Multiplexing (OFDM) symbol occupied by the RS information.

The determining circuitry 72 is adapted to determine the RS information based on the position of the OFDM symbol occupied by the RS information.

For the principle, specific embodiments, and beneficial effects of the apparatus for determining an RS information, please refer to the foregoing and the related description of the method for determining an RS information shown in FIG. 1 to FIG. 6, which will not be repeated here.

It should be noted that embodiments of the present disclosure are applicable for a 5 Generation (5G) communication system, 4G and 3G communication system, and various communication systems in the future, such as 6G and 7G.

In an embodiment of the present disclosure, a storage medium having computer instructions stored therein is provided, wherein once the computer instructions are executed, the above-mentioned method is performed. The storage medium includes a computer-readable storage medium, such as a non-volatile or non-transitory memory, the storage medium may also include an optical disk, a mechanical hard disk and a solid-state hard disk or the like.

Specifically, in embodiments of the present disclosure, the processor may be a Central Processing Unit (CPU), or other general processors, Digital Signal Processors (DSP), Application Specific Integrated Circuits (ASIC), Field Programmable Gate Arrays (FPGA) or other Programmable logic devices, discrete gates or transistor logic devices, discrete hardware components, and the like. A general processor may be a microprocessor or the processor may be any conventional processor or the like.

It should also be understood that the memory in the embodiments of the present disclosure may be either volatile memory or nonvolatile memory, or may include both volatile and nonvolatile memories. The non-volatile memory may be a read-only memory (ROM), a Programmable ROM (PROM), an Erasable PROM (EPROM), an electrically Erasable EPROM (EEPROM), or a flash memory. The volatile memory may be a random access memory (RAM) which functions as an external cache. By way of example but not limitation, various forms of random access memory are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced SDRAM (ESDRAM), Synchlink DRAM (SLDRAM), and Direct Rambus RAM (DR RAM).

In an embodiment of the present disclosure, a terminal including a memory and a processor is provided, wherein the memory has computer instructions stored therein, and the above-mentioned method can be performed, once the processor executes the computer instructions. The terminal includes, but is not limited to, terminal equipment such as mobile phones, computers, and tablets.

Specifically, a terminal in the embodiments of the present disclosure may refer to various forms of User Equipment (UE), access terminals, user units, user stations, Mobile Stations (MS), remote stations, remote terminals, mobile devices, user terminals, terminal equipment, wireless communication devices, user agents or user devices. The terminal device may also be a cellular phone, a cordless phone, a Session Initiation Protocol (SIP) phone, a Wireless Local Loop (WLL) station, a Personal Digital Assistant (PDA), a handheld device with the wireless communication function, a computing device or other processing devices connected with a wireless modem, vehicle equipments, wearable devices, terminal devices in the future 5G network, terminal devices in the future Public Land Mobile Network (PLMN), and the like, which is not limited in embodiments of the present disclosure.

Although the present disclosure is disclosed as above, the present disclosure is not limited to this. Those skilled in the art can make various changes and modifications without departing from the spirit and scope of the present disclosure. Therefore, the protection scope of the present disclosure should be subject to the scope defined by the claims.

1. A method for determining a Reference Signal (RS) information, comprising:
receiving a network configuration information, wherein the network configuration information at least comprises a position of an Orthogonal Frequency Division Multiplexing (OFDM) symbol occupied by the RS information; and
determining the RS information based on the position of the OFDM symbol occupied by the RS information.

2. The method according to claim 1, wherein the network configuration information also comprises positions of subcarriers; and
the RS information occupies one OFDM symbol and all or a part of Resource Elements (RE) in at least one Resource Block (RB) on the one OFDM symbol, wherein positions of the REs occupied in each RB are correspondent; or
the RS information occupies a plurality of OFDM symbols and all or a part of REs in at least one RB on each of the plurality of OFDM symbols, wherein positions of the REs occupied on each of the plurality of OFDM symbol are correspondent, and positions of the REs occupied in each RB are correspondent.

3. The method according to claim 1, wherein the network configuration information also comprises positions of Samples; and
the RS information occupies one OFDM symbol and all or a part of Samples in at least one Sample Resource Block (RB) on the OFDM symbol, wherein positions of the Samples occupied in each Sample RB are correspondent; or
the RS information occupies a plurality of OFDM symbols and all or part of Samples in at least one Sample RB on each of the plurality of OFDM symbols, wherein positions of the Samples occupied on each of the plurality of OFDM symbols are correspondent, and positions of the Samples occupied on each Sample RB are correspondent.

4. The method according to claim 3, wherein, on each OFDM symbol, the positions of the Samples occupied by the RS information on each Sample RB is (4y, 4y+1, 4y+2, 4y+3); or
on each OFDM symbol, the positions of the Samples occupied by the RS information on each Sample RB is (2y, 2y+1); wherein
y is a integer and y≥0.

5. The method according to claim 1, wherein the network configuration information also comprises a position of an OFDM symbol which is used for transmitting data information of data, and the method further comprises:
determining the data information based on the position of the OFDM symbol occupied by the data information; and
processing the data transmitted by a predefined processing method in response to the position occupied by the data information overlapping with the position occupied by the RS information.

6. The method according to claim 5, wherein the network configuration information also comprises positions of subcarriers which are used for transmitting data, wherein the data information comprises information after Fourier transform; and
said processing the data transmitted by the predefined processing method comprises:
mapping the data to a position occupied by the data information other than an overlapped position; or
mapping the data to a position occupied by the data information other than the position of the OFDM symbol occupied by the RS information.

7. The method according to claim 5, wherein the network configuration information also comprises positions of subcarriers occupied by the data information which is used for transmitting data, wherein the data information comprises information after Fourier transform; and
said processing the data transmitted by the predefined processing method comprises:
mapping the data information to positions of the subcarriers, and discarding data mapped to an overlapped position; or
mapping the data information to positions of the OFDM symbols and discarding data of all positions of the OFDM symbol which is mapped to the overlapping position.

8. The method according to claim 5, wherein the network configuration information also comprises positions of Samples which is used for transmitting data, wherein the data information comprises information before Fourier transform; and
said processing the data transmitted by the predefined processing method comprises:
mapping the data to a position of the data information other than an overlapped position; or
mapping the data to a position of the data information other than the position of the OFDM symbol occupied by the RS information.

9. The method according to claim 5, wherein the network configuration information also comprises positions of Samples of the data information which is used for transmitting data, wherein the data information comprises information after Fourier transform; and
said processing the data transmitted by the predefined processing method comprises:
mapping the data information to positions of the Samples, and discarding data mapped to an overlapped position; or
mapping the data information to positions of all OFDM symbols and discarding data of all positions of the OFDM symbol which is mapped to an overlapping positions.

10. (canceled)

11. A non-transitory storage medium storing one or more programs, the one or more programs comprising computer instructions, which, when executed by a processor, cause the processor to:
receive a network configuration information, wherein the network configuration information at least comprises a position of an Orthogonal Frequency Division Multiplexing (OFDM) symbol occupied by the RS information; and
determine the RS information based on the position of the OFDM symbol occupied by the RS information.

12. A terminal comprising a memory and a processor, wherein the memory has computer instructions stored therein, which, when executed by a processor, cause the processor to:
receive a network configuration information, wherein the network configuration information at least comprises a position of an Orthogonal Frequency Division Multiplexing (OFDM) symbol occupied by the RS information; and
determine the RS information based on the position of the OFDM symbol occupied by the RS information.

13. The non-transitory storage medium according to claim 11, wherein the network configuration information also comprises positions of subcarriers; and
the RS information occupies one OFDM symbol and all or a part of Resource Elements (RE) in at least one Resource Block (RB) on the one OFDM symbol, wherein positions of the REs occupied in each RB are correspondent; or
the RS information occupies a plurality of OFDM symbols and all or a part of REs in at least one RB on each of the plurality of OFDM symbols, wherein positions of the REs occupied on each of the plurality of OFDM symbol are correspondent, and positions of the REs occupied in each RB are correspondent.

14. The non-transitory storage medium according to claim 11, wherein the network configuration information also comprises positions of Samples; and
the RS information occupies one OFDM symbol and all or a part of Samples in at least one Sample Resource Block (RB) on the OFDM symbol, wherein positions of the Samples occupied in each Sample RB are correspondent; or
the RS information occupies a plurality of OFDM symbols and all or part of Samples in at least one Sample RB on each of the plurality of OFDM symbols, wherein positions of the Samples occupied on each of the plurality of OFDM symbols are correspondent, and positions of the Samples occupied on each Sample RB are correspondent.

15. The non-transitory storage medium according to claim 14, wherein on each OFDM symbol, the positions of the Samples occupied by the RS information on each Sample RB is (4y, 4y+1, 4y+2, 4y+3); or
on each OFDM symbol, the positions of the Samples occupied by the RS information on each Sample RB is (2y, 2y+1); wherein
y is a integer and y≥0.

16. The non-transitory storage medium according to claim 11, wherein the network configuration information also comprises a position of an OFDM symbol which is used for transmitting data information of data, and the method further comprises:
determining the data information based on the position of the OFDM symbol occupied by the data information; and
processing the data transmitted by a predefined processing method in response to the position occupied by the data information overlapping with the position occupied by the RS information.

17. The non-transitory storage medium according to claim 16, wherein the network configuration information also comprises positions of subcarriers which are used for transmitting data, wherein the data information comprises information after Fourier transform; and
said processing the data transmitted by the predefined processing method comprises:
mapping the data to a position occupied by the data information other than an overlapped position; or
mapping the data to a position occupied by the data information other than the position of the OFDM symbol occupied by the RS information.

18. The non-transitory storage medium according to claim 16, wherein the network configuration information also comprises positions of subcarriers occupied by the data information which is used for transmitting data, wherein the data information comprises information after Fourier transform; and
said processing the data transmitted by the predefined processing method comprises:
mapping the data information to positions of the subcarriers, and discarding data mapped to an overlapped position; or
mapping the data information to positions of the OFDM symbols and discarding data of all positions of the OFDM symbol which is mapped to the overlapping position.

19. The non-transitory storage medium according to claim 16, wherein the network configuration information also comprises positions of Samples which is used for transmitting data, wherein the data information comprises information before Fourier transform; and
said processing the data transmitted by the predefined processing method comprises:
mapping the data to a position of the data information other than an overlapped position; or
mapping the data to a position of the data information other than the position of the OFDM symbol occupied by the RS information.

20. The non-transitory storage medium according to claim 16, wherein the network configuration information also comprises positions of Samples of the data information which is used for transmitting data, wherein the data information comprises information after Fourier transform; and
said processing the data transmitted by the predefined processing method comprises:
mapping the data information to positions of the Samples, and discarding data mapped to an overlapped position; or
mapping the data information to positions of all OFDM symbols and discarding data of all positions of the OFDM symbol which is mapped to an overlapping positions.

21. The terminal storage medium according to claim 12, wherein the network configuration information also comprises positions of subcarriers; and
the RS information occupies one OFDM symbol and all or a part of Resource Elements (RE) in at least one Resource Block (RB) on the one OFDM symbol, wherein positions of the REs occupied in each RB are correspondent; or
the RS information occupies a plurality of OFDM symbols and all or a part of REs in at least one RB on each of the plurality of OFDM symbols, wherein positions of the REs occupied on each of the plurality of OFDM symbol are correspondent, and positions of the REs occupied in each RB are correspondent.
